(19) United States
(12) Patent Application Publication
(10) Pub. No.: US 2004/0140201 A1
(43) Pub. Date: Jul. 22, 2004

(54) Electrode module

(76) Inventor: Norikazu Horikawa, Tokyo (JP)

Correspondence Address: BELL, BOYD & LLOYD, LLC, P. O. BOX 1135, CHICAGO, IL, 60690-1135, US

(21) Appl. No.: 10/466,648

(22) PCT Filed: Jan. 16, 2002
(86) PCT No.: PCT/JP02/00250

(30) Foreign Application Priority Data
Jan. 19, 2001 (JP) 200112531
Jan. 19, 2001 (JP) 200112532

(51) Int. Cl. H01M 8/00; C25D 17/00

(52) U.S. Cl. 204/242; 429/12

(57) ABSTRACT

The present invention is relative to a fuel cell and an electrode module forming the fuel cell. The electrode module EM supports an electrolyte film (11) containing a proton conductor, capable of conducting protons under a non-humidifying condition, by a frame (20) of a preset shape. A fuel cell (30) includes an electrode module EM and a cooling channel on at least one side of this electrode module EM. This electrode module EM is made up by a frame (20) supporting the electrolyte film (11), a film of a porous fuel transmitting material (17) carrying a catalyst and a film of a porous oxygen transmitting material (18) carrying a catalyst layer and particles of a hydrophobic material. This fuel cell can be driven under a dry environment and under broad operating temperature conditions. In addition, scalable cells from a cell of a small capacity to a large capacity may be constructed with the same module.

### TECHNICAL FIELD

This invention relates to an electrode module, a fuel cell and a cell stack. More particularly, it relates to an electrode module, a fuel cell and a cell stack which render it possible to realize a scalable cell from a small capacity cell up to a large capacity cell.

### BACKGROUND ART

In general, a fuel cell forms a stack, comprised of plural cells, coupled together, and humidifying means. An electrode module 101, termed an electrode assembly (MEA) forming a cell, is made up by a catalyst layer 103 of, for example, Pt, mounted to the fuel side of an electrolyte film 102, a fuel 104, such as a porous sheet of carbon fibers, carrying catalyst particles of, for example, Pt, on its junction surface, a catalyst layer 105 of, for example, Pt, mounted to an oxygen side (air side) of the electrolyte film 102, and a film of an oxygen transmitting material 106, such as a porous sheet of carbon fibers, exhibiting hydrophobic effect, carrying particles of a hydrophobic material, such as polytetrafluoroethylene, on its junction surface, as shown in FIG. 1.

As the electrolyte film 102, an ion exchange membrane of for example perfluorosulfonic resin, such as Naphion (trademark of a product manufactured by Du Pont), is used to transport protons under the transporting action of water molecules.

However, if the perfluorosulfonic resin is used as the electrolyte film 102, there were constraint conditions, such as the upper limit of the operating temperature of the perfluorosulfonic resin being approximately 80 degrees, or the necessity for interposition of water. Consequently, the fuel gas and oxygen (air) need to be humidified. Moreover, water is yielded by chemical reaction, during the operation of the fuel cell, such that, for operation as a fuel cell, it is necessary to perform complex management, such as moisture control of the membrane, optimization of the flow rate of the fuel gas or water control.

For power generation using a fuel cell, auxiliary units for supplying the fuel to a main body unit of the fuel cell in stability are required. Although not shown, a steam generator for steam generation or a humidifier for humidifying the fuel gases, are needed. In the case of a fuel cell having a flat plate cell structure, it is necessary to provide separators 110 to 112 having a channel structure for controlling the fuel gas flow in the main body unit of the fuel cell and for producing a pressure differential for excluding generated water or precipitated water from the gases. This raised a problem in connection with cost reduction of the fuel cell. Meanwhile, a water-transmitting membrane 113 is interposed between the separators 110, 112.

### DISCLOSURE OF THE INVENTION

It is therefore an object of the present invention to provide an electrode module, a fuel cell and a cell stack which render it possible to realize scalable cells, from a cell of a small capacity to a cell of a large capacity, with the use of the same module.

It is another object of the present invention to provide an electrode module, a fuel cell and a cell stack which assure operation under a dry environment or under broad operating temperature conditions, without the necessity of humidifying the fuel cells.

It is still another object of the present invention to provide an electrode module, a fuel cell and a cell stack which may be applied with advantage to a mass production process to achieve marked cost reduction.

It is yet another object of the present invention to provide a fuel cell which, through using an electrolyte membrane, containing a proton conductor, capable of conducting protons under a non-humidifying condition to an electrode module, optimizes characteristics or performance to render precise control of the water or gas.

For accomplishing the above object, the present invention provides an electrode module comprising: an electrolyte film containing a proton conductor capable of conducting protons under a non-humidifying condition; and a frame for supporting the electrolyte film. By holding the electrolyte film by the frame, a thin film can be handled easily, while film handling in case of layering another film on a thin film may be facilitated. By using the frame as a mounting adherent surface for another member, the fuel side and the oxygen side, separated from each other, may be sealed reliably.

The proton conductor is consisted mainly of a carbonaceous material to which a proton dissociative group is introduced. The ‘dissociation of protons (H⁺)’ means ‘separation of protons (from the functional group) on electrical dissociation’ and the ‘proton dissociating groups’ means ‘a functional group from which protons may be desorbed on electrical dissociation’. Since the proton dissociating groups are introduced with the carbonaceous material, composed mainly of carbon, as a matrix, there is no necessity of supplying the moisture from outside, in a manner different from the case of using a customary ion exchanged film, such as conventional perfluorosulfonic acid resin, thus simplifying the system. Since there is no necessity of interposing the moisture in proton transmission, the cell can be used in a dry environment over a broad temperature range, thus allowing to cope with various shapes of the electrical equipment through use of the frame of the desired shape as described above. The carbonaceous material is preferably fullerene molecules. The electrolyte film may also contain a binder.

The frame may be formed with a contact portion with the electrolyte film. By forming the contact portion in this manner, electrical conduction can be established at a preset position. The frame may be formed of an electrically conductive material so that the frame will be electrically connected to other electrically connectable members. By so doing, the frame itself is electrically conductive to render it possible to provide for electrical conduction at any desired position of the frame.

When the frame is formed of an insulating material, it is desirable to provide a portion, with which the frame may be contacted electrically with an external member, as a portion of the metal layer for the electrode. In this case, there is no necessity for providing for insulation between the electrolyte film and the frame, because the frame itself is an insulating material.

The frame may be formed of a composite material, which composite material is preferably composed at least of a glass material and an epoxy resin. By constructing the frame from the composite material, it becomes possible to provide for sufficient reduction in weight and sufficient strength of the frame. By judiciously selecting the material usable as the composite material, it becomes possible for the frame to have adhesion and sealing functions with respect to other components.

It is preferred that an electrolyte film and a catalytic layer be formed on the electrolyte film by a film-forming process at least containing sputtering, plating and pasting. Since the electrolyte film is held by the frame and the proton conductor is composed of fullerene molecules, as a matrix, and proton dissociating groups, the film-forming technique such as sputtering, plating or pasting, may be directly applied to the electrolyte film, thus facilitating depsoition of plural films.

One or more electrode films and one or more catalyst layers may be layered alternately to form a multiple layers of two or more films.

For accomplishing the above object, the present invention also provides an electrode module including a frame for supporting an electrolyte film, a film of a porous fuel transmitting material carrying a catalyst layer, and a film of a porous oxygen transmitting material carrying a catalyst layer and particles of a hydrophobic material.

At least one of the film of the fuel transmitting material and the film of the oxygen transmitting material lined on the frame is larger in size than the inner size of the frame, with the opposite side film being smaller in size than the inner size of the frame.

By forming the electrode module in this manner, one of the films is placed within the frame, so that it is possible to avoid direct contact of the frame with the film disposed within the frame.

The present invention also provides an electrode module including a frame for supporting an electrolyte film, a film of a porous fuel transmitting material carrying a catalyst, and a film of a porous oxygen transmitting material, carrying a catalyst layer, and particles of a hydrophobic material. At least one of the film of the fuel transmitting material and the film of the oxygen transmitting material is larger in size on the film lining side, with respect to the inner size of the frame, with the opposite side film being smaller in size.

More specifically, a fuel cell according to the present invention includes a frame for supporting an electrolyte film, a metal layer with a catalyst layer for an electrode provided on each side of the electrolyte film, a film of a porous fuel transmitting material carrying a catalyst, and a film of a porous oxygen transmitting material carrying a catalyst layer and particles of a hydrophobic material, and a duct for cooling water provided on at least one side of the electrode module.

By forming the fuel cell in this manner, cooling may be made from outside the electrode module to prevent its overheating.

In this fuel cell, at least one of the film of the fuel transmitting material and the film of the oxygen transmitting material lined on the frame is preferably larger in size than the inner size of the frame, with the opposite side film being smaller in size than the inner size of the frame. By forming the fuel cell in this manner, one of the films is placed within the frame, so that it becomes possible to evade direct contact between the frame and the film placed within the frame.

A cell stack according to the present invention is comprised of any of plural fuel cells according to the present invention, stacked together and arranged in a casing, with the cells being then secured as pressure is applied through a pressuring plate to the portions of the frame supporting the electrolyte film.

By forming the cell stack in this manner, the pressure may be applied at the frame portions when pressuring the stack to prevent the pressure from being applied to the stacked films.

Another cell stack according to the present invention is comprised of any of plural fuel cells according to the present invention, stacked together and arranged in a casing, as a duct for cooling water is formed between the neighboring fuel cells, with the cells being then secured as pressure is applied through a pressuring plate to the portions of the frame supporting the electrolyte film.

By forming the cell stack in this manner, cooling may be applied to between neighboring fuel cells, in addition to cooling in the respective fuel cells as described above, to water-cool the fuel cells from their peripheral sides, in consideration of the overheating otherwise caused by the reaction temperature which may even reach as high as about 100° C.

By forming the electrode module, fuel cell and the cell stack, as described above, it is possible to realize scalable cells from the cells of the small capacity to those of the large capacity, with the use of the same module. The electrode module may be of an optimum size and structure which will optimize the dispersion of generated water or heat, electrical connection or cooling, and hence lends itself to mass production process to achieve marked reduction in cost.

That is, with the electrode module, fuel cell and the cell stack, described above, the moisture content control may be performed easily to maintain the strength of the electrolyte film. By driving at 100° C., the moisture content may be vaporized off. Moreover, film deposition may be achieved by plating or coating. The surface itself of the electrolyte film may be surface processed, such as by sputtering, fine working, semiconductor processing or by etching.

For accomplishing the above object, the present invention also provides a fuel cell comprising a cell system, in which the cell system includes an air side plate capable of being supplied with air, at least one electrode module mounted air-tightly to the air side plate and having a surface contacting with oxygen, a hermetically sealed plate for hermetically sealing the surface of the electrode module corresponding to a fuel side of the electrode module opposite to the side contacting with oxygen, and an injection port for introducing a fuel gas between the hermetically sealed plate and the surface of the electrode module contacting with the fuel side.

A fuel cell according to the present invention includes a cell system, in which the cell system includes at least one electrode module having an air side plate capable of being supplied with air and a surface mounted air-tightly to the air side plate and provided with a surface contacting with oxygen, and a constituent member having a surface contacting with a fuel, lying oppositely to the oxygen contacting surface. The fuel contacting surfaces of the constituent members face each other with a spacer in-between. A fuel gas is supplied to the facing surfaces.

A fuel cell according to the present invention includes a cell system, in which the cell system includes at least one electrode module having an air side plate capable of being supplied with air and a surface mounted air-tightly to the air side plate and provided with a surface contacting with oxygen, and a plurality of constituent members each having a surface contacting with a fuel, lying oppositely to the oxygen contacting surface. The fuel contacting surfaces of the constituent members face one another with a plurality of spacers in-between. The spacers are provided at a preset interval from one another, to form a plurality of columns. A fuel gas is supplied to the facing surfaces.

With the fuel cell of the present invention, described above, cells of various capacities may be constructed with the same module to achieve high mass producibility and consequent reduction in cost.

The air side plate, the electrode module and the hermetically sealed plate are of desired shapes. At least the air side plate, electrode module and the hermetically sealed plate are of substantially the same outer shape.

By so doing, it is possible to provide fuel cells of an optimum shape which are matched to the shape of preset electrical equipment, such as television receiver, video tape recorder, portable camera, digital video camera, digital camera, portable or standstill type personal computer, facsimile, information terminals, including portable telephone sets, printers, navigation system, other OA equipment, lighting equipment or to domestic electrical utensils.

The electrical connection across a plurality of the electrode modules in case there are such plural electrode modules is preferably made by a connection pattern provided on a surface of the air side plate lined with the electrode module, a portion of an electrode film forming the electrode module being contacted with the connection pattern and also contacted with a connection pattern of another electrode module through a support having a contact function of contacting with an opposite side of the frame to assure electrical connection. This renders it possible to render the cell as thin as possible and yet to assure the electrical connection.

Preferably, separators having ducts for a fuel gas and air are arranged on both lateral sides of the electrode module to enable efficient supply of the fuel gas or air towards the electrode module.

At least one of the plates may be constructed as a flexible sheet. By forming the plate(s) as a flexible sheet, deformation loads up to a certain magnitude can be withstood, while registration or mounting errors can be absorbed on the side flexible sheet.

The electrode module may be comprised of an electrolyte film, containing a proton conductor capable of conducting protons in a non-humidifying condition, and a frame supporting the electrolyte film. This proton conductor is comprised of proton dissociating groups introduced into a carbonaceous material which is mainly composed of carbon. The ‘dissociation of protons (H⁺)’ means ‘separation of protons (from the functional group) on electrical dissociation’ and the ‘proton dissociating groups’ means ‘a functional group from which protons may be desorbed on electrical dissociation’. Meanwhile, the carbonaceous material is preferably fullerene molecules, while the electrolyte film may be loaded with a binder. The binder, if used, operates for bonding to achieve a proton conductor of a sufficient strength.

Since the proton dissociating groups are introduced into the carbonaceous material, composed mainly of carbon, as a matrix, there is no necessity of supplying the moisture from outside, in a manner different from the case of using an ion exchanged film, such as conventional perfluorosulfonic acid resin, thus simplifying the system. Since there is no necessity of interposing the moisture in proton transmission, the cell can be used in a dry environment over a broad temperature range to allow for a simplified separator. The frame is preferably formed with a contact portion with respect to the electrode film. The above-described structure facilitates the electrical connection.

For accomplishing the above object, the present invention also provides fuel cell comprising a cell system, in which the cell system includes at least one electrode module having an air side plate capable of being supplied with air and a surface mounted air-tightly to the air side plate and which is provided with a surface contacting with oxygen. A plurality of constituent members each include a surface contacting with a fuel, lying oppositely to the oxygen contacting surface. The fuel contacting surfaces of the constituent members face one another with a plurality of spacers in-between. The spacers are provided at a preset interval from one another, to form a plurality of columns. A fuel gas is supplied under pressure to the facing surfaces to produce a pressure difference with respect to the air side.

By this structure, it becomes possible to arrange plural cells of the concatenated structure to achieve fuel cells in a wide spectrum from a small capacity cell to the large capacity cell. Moreover, the air side plate and the electrode module are of the desired shape and, by setting the outer shape at least of the air side plate and the electrode module to substantially same outer shape, it is possible to provide a fuel cell matched to the electrical equipment.

Moreover, by adjusting the pressure of the pressurized fuel gas to a constant value and by controlling the supply quantity to compensate the depressurization caused by fuel gas consumption, it is possible to cause the gas pressure to be unchanged, as the fuel gas is used, to maintain a constant output.

Other objects, features and advantages of the present invention will become more apparent from reading the embodiments of the present invention as shown in the drawings.

### BRIEF DESCRIPTION OF THE DRAWINGS

FIG. 1 schematically shows the structure of a conventional solid polymer type fuel cell.

FIG. 2 is a cross-sectional view of a fuel cell according to an embodiment of the present invention.

FIG. 3 is a perspective view of an electrode module.

FIGS. 4A and 4B show exemplary structures of fullerene polyhydroxide having fullerene molecules as a matrix and including proton dissociating groups.

FIGS. 5A, 5B and 5C are schematic views showing exemplary structures having fullerene molecules as a matrix and also having proton dissociating groups.

FIG. 6 illustrate several examples of the carbon clusters.

FIG. 7 illustrates examples of carbon clusters having a diamond structure.

FIG. 8 illustrates examples of carbon clusters having open ends.

FIG. 9 illustrates examples of carbon clusters made up of various clusters.

FIG. 10 illustrates the structure of a self-humidifying electrode film.

FIG. 11 is a perspective view showing a modification of an electrode module according to the present invention.

FIG. 12 is a bottom plan view of the electrode module shown in FIG. 3.

FIG. 13 is a bottom view of an electrode module shown in FIG. 11.

FIG. 14 is a cross-sectional view showing a further modification of a fuel cell according to the present invention.

FIG. 15 is a cross-sectional view showing a still further modification of a fuel cell according to the present invention.

FIG. 16 is a plan view showing an embodiment of a fuel cell according to the present invention.

FIG. 17 is a schematic cross-sectional view of the fuel cell according to the present invention.

FIG. 18 is a plan view of a stack according to the present invention.

FIG. 19 is a schematic cross-sectional view showing an embodiment of a stack according to the present invention.

FIG. 20 is an exploded perspective view showing a modification of a fuel cell according to the present invention.

FIG. 21 is a bottom view showing the back side of an air side plate, looking from a seal frame, showing a modification of a fuel cell shown in FIG. 20.

FIG. 22 is a side view showing a further embodiment of a fuel cell according to the present invention.

FIG. 23 is a cross-sectional view showing the state of electrical connection across different electrode modules.

FIG. 24 is a cross-sectional view showing another exemplary structure of a cell.

FIG. 25 is a cross-sectional view showing another exemplary structure of a cell.

FIG. 26 is a cross-sectional view showing another exemplary structure of the cell.

FIG. 27 is a schematic cross-sectional view showing a further example of a fuel cell including a separator.

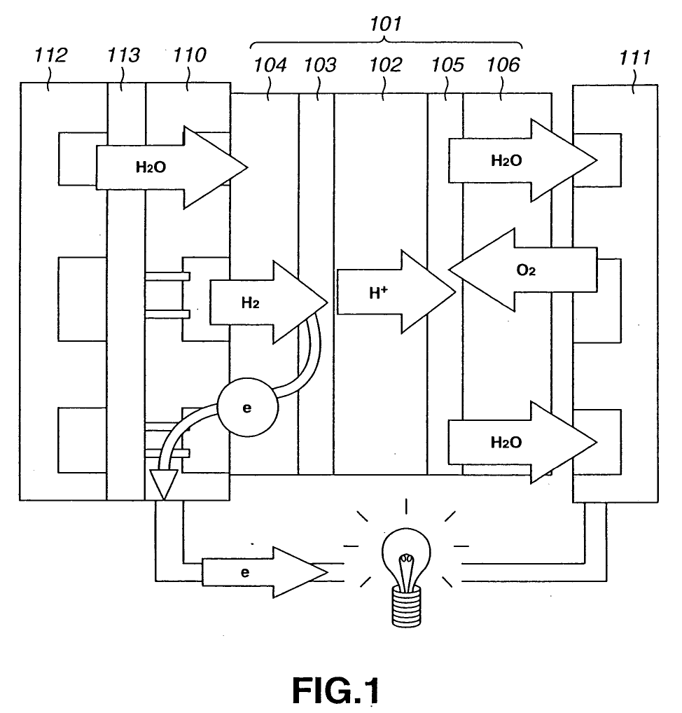

### BEST MODE FOR CARRYING OUT THE INVENTION

Referring to the drawings, certain preferred embodiments of the present invention are explained in detail.

First, an electrode module EM of a fuel cell, embodying the present invention, is explained.

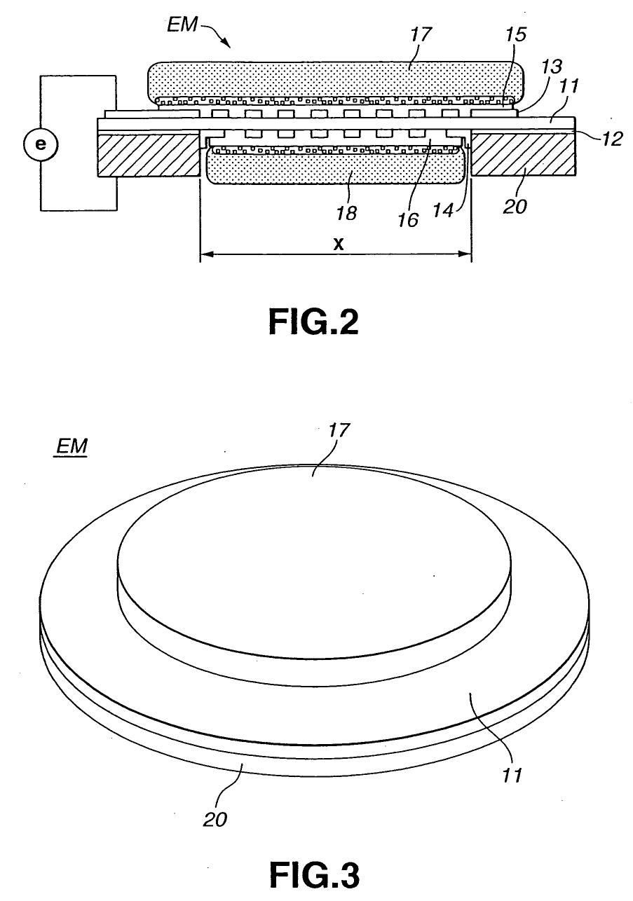

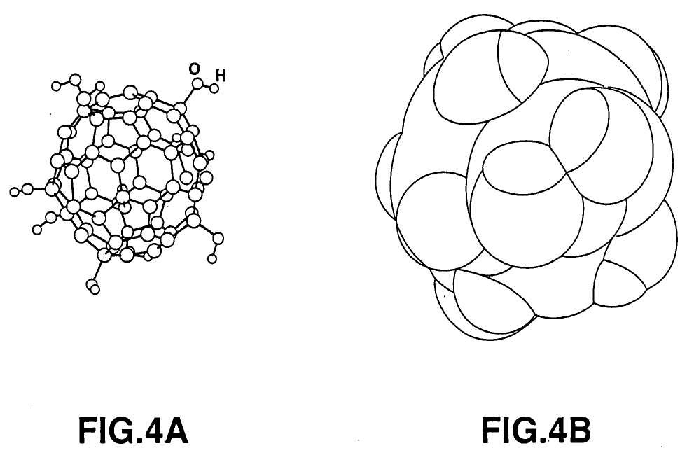

The electrode module EM is comprised of an electrolyte film 11, containing a proton conductor, capable of proton conduction under a non-humidifying condition, and a frame 20 of a preset shape, supporting the electrode module EM, as shown in FIG. 2.

The proton conductor of the present embodiment is formed by a carbonaceous material, mainly composed of carbon, and into which have been introduced proton dissociating groups. As the carbonaceous material, fullerene molecules, for example, are preferred. The electrolyte film may be also be loaded with a binder.

The frame 20 is explained further. The frame 20 is formed of an electrically conductive material, and has, on its upper and lower surfaces, contact portions with metal layers 13, 14, as shown in FIG. 2. The frame 20 is electrically connected to another electrically connecting member.

The frame 20 may be formed of an insulating material. In this case, a portion of a metal layer for electrode 14, provided on one surface of the electrolyte film 11 of the frame 20, is designed as a portion for establishing electrical contact with an outside member.

The frame 20 may be formed of a composite material. This composite material may preferably be formed at least by a glass material and an epoxy resin.

On both surfaces of the electrolyte film 11, the metal layers 13, 14 and catalyst layers 15, 16 can be formed by a film forming process including at least any one or more of sputtering, plating and paste coating.

The metal layers 13, 14 and catalyst layers 15, 16 may be alternately layered to construct a multi-layered film comprised of at least two or more layers.

Referring to FIG. 2, an electrode module Em according to the present invention includes the frame 20, carrying the electrolyte film 11, a film of a porous fuel-transmitting material 17, and a film of a porous oxygen transmitting material 18, carrying a catalyst layer and particles of a hydrophobic material. At least one of the film of the porous fuel-transmitting material 17 and the film of the porous oxygen transmitting material 18 lying on the film lining side is larger than the in-frame size X of the frame 20, with the other film being smaller in size than the in-frame size X. The metal layers for the electrodes 13, 14 and the catalyst layers 15, 16 for dissociating the hydrogen gas into protons and for assuring transmission of the protons therethrough more reliably may be provided on both sides of the electrolyte film 11.

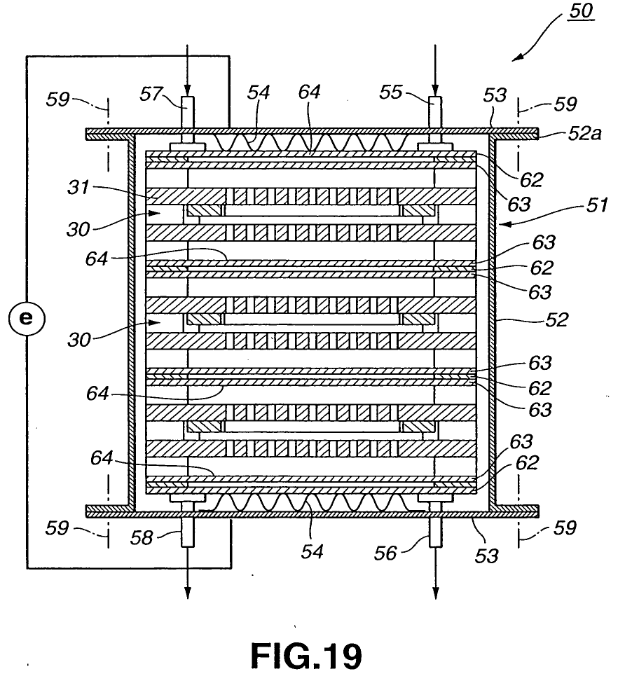

Referring to FIGS. 18 and 19, explained later, the fuel cell 30 of the present invention is made up of an electrode module EM and a cooling channel formed on at least one side of this electrode module EM. The electrode module EM includes the frame 20, carrying the electrolyte film 11, the film of a porous fuel-transmitting material 17, carrying a catalyst, and the film of a porous oxygen transmitting material 18, carrying a catalyst layer and particles of a hydrophobic material. A cooling channel 64 is formed by a cooling separator 63 and a spacer 62.

It should be noted that, in the embodying the present invention EM, at least one of the film of the porous fuel-transmitting material 17 and the film of the porous oxygen transmitting material 18 lying on the film lining side is larger in size than the in-frame size X of the frame 2, with the other being smaller in size than the in-frame size X.

A cell stack 50 is formed by layering a plural number of the fuel cells 30, arraying the cells in a casing 51, pressurizing the cells at the portions of the frames 20 carrying the electrolyte films 11 through pressuring plates 54, and by securing the cells together.

Moreover, a cell stack 50 is formed by layering a plural number of the fuel cells 30, arraying the cells in a casing 51, as cooling water channels are formed between the neighboring fuel cells 30, pressurizing the cells at the portions of the frames 20 carrying the electrolyte films 11 through pressuring plates 54, and securing the cells together.

Embodiments

Referring to the drawings, more specified embodiments of the present invention are hereinafter explained. It should be noted that the components or arraying modes now explained are not intended to limit the present invention but may be modified within the scope of the invention.

The electrode module EM of the present embodiment of the fuel cell is comprised of an electrolyte film 11, loaded with a proton conductor, capable of transmitting protons under a non-humidifying condition, and the frame 20 of a preset shape, supporting the electrolyte film 11, as shown in FIGS. 2 and 3. The proton conductor of the present embodiment is comprised of a carbonaceous material, mainly composed of carbon, and which is loaded with proton dissociating groups. The carbonaceous material may, for example, be fullerene molecules, while the electrolyte film may be loaded with a binder.

As the proton conductor, fullerene polyhydroxide C₆₀(OH)₁₂ is a generic appellation of a compound comprised of fullerene, to which plural hydroxy groups are attached, and is routinely termed fullerenol. As a matter of fact, synthesis examples for fullerenol were first reported by Chiang et al in 1992 (Chiang, L. Y.; Swirczewski, J. W.; HSU, C. S.; Choedhury, S. K.; Cameron, S; Creegan, K. J. Chem. Soc. Chem. Commun. 1992, 1791). Since that time, fullerenol into which an amount in excess of a preset amount of hydroxy groups have been introduced has attracted attention in particular as to its being water-soluble, and has been investigated mainly in the bio-related technical field.

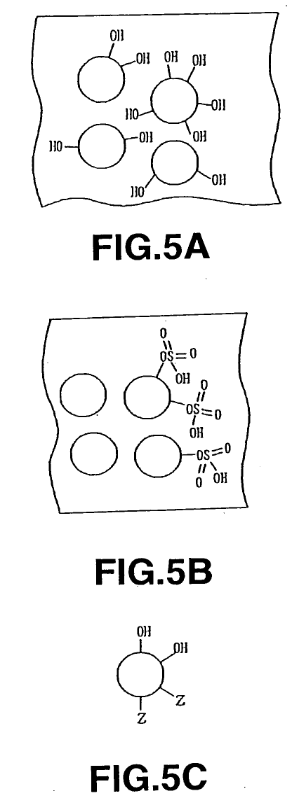

Fullerenol is formed into an aggregate, so that interaction will be produced between hydroxy groups of neighboring fullerenol molecules as shown schematically in FIG. 5A, in which ◯ indicates a fullerene molecule. As a macroscopic assembly, this aggregate exhibits high proton conductivity (in other words, dissociating properties of H⁺ from phenolic hydroxy groups of the fullerene molecules).

In place of fullerenol, a fullerene aggregate having plural —OSO₃H groups may also be used as a proton conductor. Fullerene polyhydroxide, shown in FIG. 5B, in which OH groups are substituted for OSO₃H groups, that is, hydrogen sulfate (ester) type fullerenol, was also reported by Chiang et al in 1994 (Chiang, L. Y.; Wang, L. Y.; Swirczewski, J. W.; Soled, S.; Cameron, S. J. Org. Chem. 1994, 59, 3960). The hydrogen sulfate ester type fullerenol may include only OSO₃H groups in one molecule, or may contain a plural number each of this group and the hydroxy group in one molecule.

The proton conductivity exhibited by an aggregate of a large number of fullerene derivatives as a bulk is such proton conductivity in which a large quantity of hydroxy groups inherently included in the molecules or protons derived from the —OSO₃H groups take part in the migration. Thus, there is no necessity of capturing hydrogen or protons, derived from stream molecules, from the atmosphere, while there is no necessity of absorbing the moisture from outside, above all, from outside air, there being no constraint as to atmosphere. On the other hand, fullerene, as a substrate of the molecules of the fullerene derivatives has electrophilic properties. It may be contemplated that this contributes appreciably to promote ionization of hydrogen ions not only in —OSO₃H groups having high acidity but also in hydroxy groups.

Since a rather large number of hydroxy groups and —OSO₃H groups can be introduced into one fullerene molecule, the number density in the unit area of the proton conductor participating in the conduction is increased appreciably.

Since the major portion of the proton conductor of the present embodiment is made up by carbon atoms of fullerene, the proton conductor is lightweight and is scarcely transmuted, while being free of pollutants. The production cost of fullerene is also falling rapidly. Fullerene is thought to be a carbonaceous material superior to any other materials in light of resources, environment and economy.

Moreover, the proton dissociating groups are not limited to the aforementioned hydroxy or —OSO₃H groups. That is, it is only sufficient if these dissociating groups are represented by the formula —XH where X is an optional atom or group of atoms having bivalent bonds. Moreover, it is sufficient if these groups are represented by the formula —OH or by a formula —YOH, where Y is an optional atom or group of atoms having bivalent bonds.

Specifically, the proton dissociating groups are preferably any of —COOH, —SO₃H, —OPO(OH)₂, in addition to the aforementioned —OH and —OSO₃H.

Moreover, in the present embodiment, electrophilic groups, such as nitro groups, carbonyl groups, carboxyl groups, nitrile groups, halogenated alkyl groups or halogen atoms, such as fluorine or chlorine atoms, are preferably introduced, along with the proton dissociating groups, into the carbon atoms making up the fullerene molecules. FIG. 5C shows fullerene molecules into which Z has been introduced in addition to —OH. Specifically, Z may be —NO₂, —CN, —F, —Cl, —COOR, —CHO, —COR, —CF₃ or —SO₃CF₃, where R denotes an alkyl group. If these electrophilic groups co-exist, protons tend to be dissociated from the above proton dissociating groups due to the electrophilicity of these electrophilic groups.

The number of the groups capable of dissociating protons introduced into the fullerene molecules is preferably not less than five, although it may be any optional number within the range of the number of carbon atoms making up the fullerene molecules. Meanwhile, if π-electron properties of fullerene are to be maintained and effective electrophilicity is to be manifested, the number of the above groups is desirably not larger than one half of the number of carbon atoms making up the fullerene.

For synthesizing the fullerene derivatives, used as a proton conductor, it is sufficient if known processing methods, such as acid processing or hydrolysis, are applied in any optional combination to the powders of the fullerene molecules to introduce desired proton dissociating groups into the constituent carbon atoms of the fullerene molecules.

More specifically, fullerene polyhydroxide was synthesized on the basis of the teaching in a reference material (Chiang, L. Y.; Wang, L. Y.; Swirczewsky, J. W.; Soled, S.; Cameron, S. J. Org. Chem. 1994, 59, 3960). 2 g of a C60/C70 mixture, containing about 15% of C70, were charged into 30 ml of fuming sulfuric acid and stirred for three days in a nitrogen atmosphere as the temperature was maintained at 60° C. The resulting mixture was charged gradually into anhydrous diethylether, cooled in a glacial bath, and resulting precipitates were fractionated on centrifugation and washed thrice with diethylether and thrice with a 2:1 liquid mixture of diethylether and acetonitrile. The resulting product was dried in vacuum at 40° C. The resulting dried mass was charged into 60 ml of ion exchanged water and agitated for ten hours under bubbling with nitrogen at 85° C. The reaction product was freed by centrifugation of a precipitated product which then was washed several times with pure water. After repeated centrifugation, the resulting product was dried in vacuo at 40° C. to a brownish powdered product. This product was subjected to FT-IR measurement. It was found that the spectrum was approximately coincident with the IR spectrum of C60(OH) 12 indicated in the above reference material, so that this powdered product was identified to be targeted fullerene polyhydroxide.

For preparing flocculated pellets of fullerene polyhydroxide, 90 mg of powders of fullerene polyhydroxide were taken and pressed unidirectionally to form a circular pellet 15 mm in diameter. The press working pressure at this time was approximately 7 ton/cm². As a result, it was found that the powders of fullerene polyhydroxide were superior in moldability, despite the fact that they were completely free of binder resins, such that the powders could be readily formed into a pellet. The pellet was approximately 300 μm in thickness.

A fullerene polyhydroxide hydrogen sulfate (full ester) was synthesized in similar manner by having reference to the aforementioned reference material. 1 mg of fullerene polyhydroxide was charged into 60 ml of fuming sulfuric acid and stirred at room temperature for three days in a nitrogen atmosphere. The so produced reaction product was charged gradually into anhydrous diethylether, cooled in a glacial bath, and resulting precipitates were fractionated on centrifugation and washed thrice with diethylether and thrice with a 2:1 liquid mixture of diethylether and acetonitrile. The resulting product was dried in vacuum at 40° C. The resulting reaction product was subjected to FT-IR measurement. It was found that the spectrum was approximately coincident with the IR spectrum of a material, the totality of hydroxy groups of which are turned into a hydrogen sulfate (ester) type, as indicated in the above reference material, such that these powders could be identified to be the target material.

For producing the flocculated pellet of fullerene polyhydroxide hydrogen sulfate ester, 70 mg of fullerene polyhydroxide hydrogen sulfate (ester) were taken and pressed unidirectionally to form a circular pellet 15 mm in diameter. The press working pressure at this time was approximately 7 tons/cm². As a result, it was found that the powders of fullerene polyhydroxide were superior in moldability, despite the fact these were completely free of binder resins, such that the powders could be readily formed into a pellet. The pellet was approximately 300 μm in thickness.

In synthesizing fullerene polyhydroxide hydrogen sulfate (partial ester), 2 g of a C60/C70 mixture containing about 15% of C70 were charged into 30 ml of fuming sulfuric acid and stirred for three days in a nitrogen atmosphere as the temperature was maintained at 60° C. The resulting product was gradually charged into diethylether cooled in a glacial bath. It should be noted that diethyether used was an non-dehydrated product. The resulting precipitates were fractionated on centrifugation and washed thrice with diethylether and thrice with a 2:1 liquid mixture of diethylether and acetonitrile. The resulting product was dried in vacuum at 40° C. The resulting reaction product was subjected to FT-IR measurement. It was found that the spectrum was approximately coincident with the IR spectrum of a fullerene derivative partially containing hydroxy groups and OSO₃H groups, as indicated in the above reference material, thus demonstrating that these powders were the targeted substance.

For producing a flocculated pellet of fullerene polyhydroxide hydrogen sulfate (ester), 80 mg of fullerene polyhydroxide, partially esterified into hydrogen sulfate, were taken and pressed unidirectionally to a circular pellet 15 mm in diameter. It was found that the powders of fullerene polyhydroxide were superior in moldability, despite the fact these they were completely free of binder resins, such that the powders could be readily formed into a pellet. The pellet was approximately 300 μm in thickness.

In the above example, a film of fullerene polyhydroxide was used as a proton conductor film. However, the proton conductor film is not limited to this example. It is noted that fullerene polyhydroxide is formed by a matrix of fullerene molecules, to the constituent carbon atoms of which hydroxy groups have been introduced. This matrix is not limited to that of fullerene molecules, it being sufficient if the matrix is a carbonaceous material composed mainly of carbon.

In this carbonaceous material, there may be contained carbon clusters, each formed by an assembly of from several to hundreds of carbon atoms, irrespective of the sorts of carbon-to-carbon bonds, or tubular carbonaceous materials (so-called carbon nanotubes).

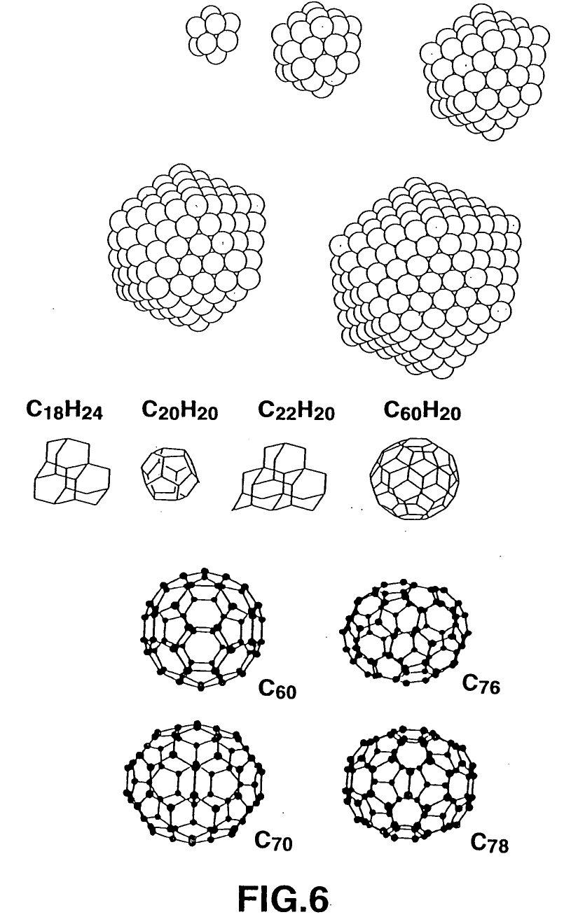

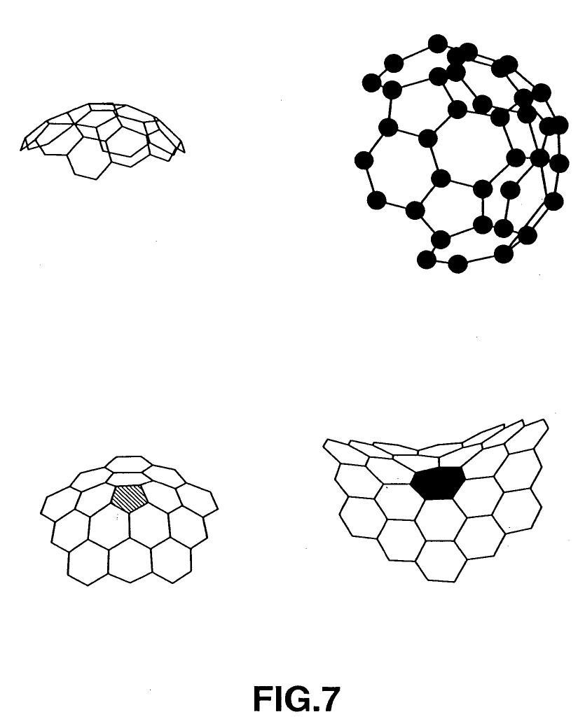

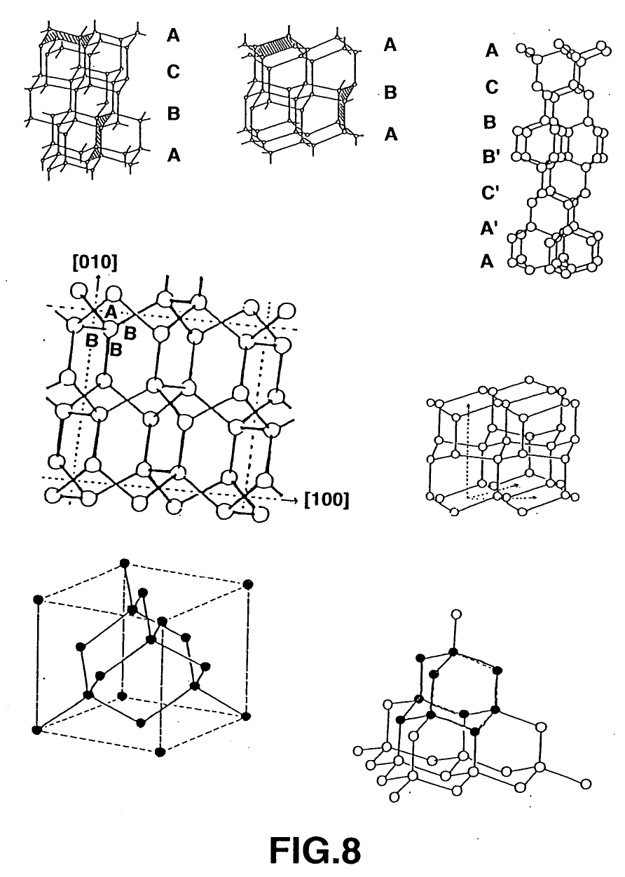

Among the carbon clusters, there are a variety of types having a closed surface structure, such as in the form of a sphere or elongated sphere, comprised of a large number of carbon atoms, as shown in FIG. 6. Among the carbon clusters, there may also be contained a carbon cluster of the above spheroidal structure partially fractured to present open end(s), as shown in FIG. 7, a carbon cluster of a diamond structure the majority of carbon atoms of which are in SP3 bond, as shown in FIG. 8, or a set of carbon clusters composed of these carbon clusters bonded together in variegated fashion, as shown in FIG. 8.

The groups introduced into the matrix of this sort are not limited to hydroxy groups, such that it is sufficient if these groups are a proton dissociating group represented by —XH and more preferably —YOH, where X and Y are any optional bivalent atoms or group of atoms, H is a hydrogen atom and O is an oxygen atom. Specifically, these groups are desirably a hydrogen sulfate (ester) group —OSO₃H, a carboxyl group —COOH, —SO₃H or —OPO(OH)₂, in addition to —OH.

If the aforementioned fullerene derivative is used as the proton conductor, this proton conductor is desirably formed only by the fullerene derivative or further includes a binder for bondage. The electrolyte film may be formed only from the film-shaped fullerene derivative, obtained on pressuring and molding the fullerene derivative, or the fullerene derivatives, bonded by the binder, may be used as the proton conductor. If the binder is used in this manner, such a proton conductor may be formed which, by bonding with the binder, exhibits a sufficient strength.

As the polymer material, usable as a binder, one or more known polymers, exhibiting film-forming properties, may be used. The amount of the polymer material in the proton conductor is set to not larger than 40 wt %. If this amount exceeds 40 wt %, hydrogen ion conductivity tends to be lowered.

The proton conductor of this structure contains the fullerene derivative as the proton conductor, and hence may exhibit hydrogen ion conductivity comparable to that of the proton conductor substantially composed only of the fullerene derivative.

Moreover, such proton conductor exhibits film forming properties proper to the polymer material, in a manner different from the proton conductor composed only of the fullerene derivative. That is, the above proton conductor may be used as a soft and pliable ionic conductive thin film, with a thickness usually not larger than 300 μm, having a strength higher than that of the powder compacted molded product of the fullerene derivative and also exhibiting a gas transmission prohibiting performance.

Meanwhile, there is no particular limitation to the aforementioned polymer material provided that the material obstructs conductivity of hydrogen ions due to reaction with the fullerene derivative to the least extent possible, and also provided that the material has film forming properties. Usually, such a high polymer material is used not exhibiting electronic conductivity and exhibiting optimum stability. Specified examples of the polymer material include polyfluoroethylene, polyvinylidene fluoride and polyvinyl alcohol. These are desirable polymer materials from the following reason.

First, polyfluoroethylene is desirable because a thin film of a higher strength can readily be formed with a smaller amount of addition thereof than with other polymer materials. The amount of addition in this case is not more than 3 wt % and preferably 0.5 to 1.5 wt %, with the thin film thickness as thin as 100 to 1 μm being usually feasible.

The reason why polyvinylidene fluoride and polyvinyl alcohol are desirable is that an ionic conductive thin film having higher gas transmission prohibiting performance can be obtained. The amount of mixing in this case may be in a range from 5 to 40 wt %.

If the amount of mixing of polyfluoroethylene, polyvinylidene fluoride or polyvinyl alcohol is less than the associated lower limit value, as described above, the film forming process may be affected adversely.

For obtaining a thin film of a proton conductor, in which the fullerene derivatives are bonded by the binder, any suitable known film-forming methods, such as pressure forming or extrusion molding, may be used.

The proton conductor may also be formed by at least one resin selected from the group consisting of polyvinyl chloride, vinyl chloride copolymers, polyethylene, polypropylene, polycarbonate, polyethylene oxide, polyphenylene oxide, perfluorosulfonic resin and derivatives thereof, and a fullerene derivative.

The content of the resin is preferably not larger than 50 wt % because the content in excess of 50 wt % tends to lower proton conductivity.

In case the proton conductor is set to contain the above resin, it is possible to produce a thin film having high moldability and a higher strength. The so produced thin film may be used as a thin film having superior film strength and superior gas transmission prohibiting performance, in addition to having superior resistance to acid and superior thermal resistance.

It is noted that polyvinyl chloride and the vinyl chloride based copolymers are desirable resins because of superior resistance to acid and superior thermal resistance. Meanwhile, the vinyl chloride based copolymer is copolymer of a vinyl chloride and a monomer copolymerizable therewith, such as vinyl chloride-vinylidene chloride copolymer or vinyl chloride-vinyl acetate copolymer.

It is noted that polyethylene, polypropylene, polyethylene oxide and polyphenylene oxide are resins superior in resistance to acids.

Meanwhile, polycarbonate is a transparent non-crystalline resin, superior in thermal resistance and low temperature characteristics, and which is usable over a wide temperature range. It is also superior in shock resistance.

The perfluorosulfonic acid based resin is superior in resistance to acid and thermal resistance, while being superior in weather-proofness, and hence is not changed significantly in its characteristics on exposure to hostile temperature or on prolonged exposure to light beams.

When the above-mentioned resins are contained in the proton conductor, the resulting proton conductor is insusceptible to deterioration due to oxidation, even in case the proton conductor is increased in acidity due to dissociation of protons (H⁺), and moreover is superior in durability, so that it can be used conveniently as a proton conductive thin film. In addition, the proton conductor exhibits high conductivity over a wide range inclusive of the ambient temperature.

The proton conductor may also be a high conductivity glass of protons (hydrogen ions) prepared by the sol/gel method. This high conductivity glass is, for example, a phosphoric acid-silicate (P₂O₅—SiO₂) based glass and may be prepared as glass by hydrolyzing a metal alkoxide starting material and by heating the resulting gel at 500 to 800° C. This glass has fine pores, on the order of 2 nm, in which the moisture is adsorbed to accelerate proton migration.

The proton conductor may also be an organic/inorganic hybrid ion exchange membrane, which is a composite membrane in which polyethylene oxide (PEO), polypropylene oxide (PPO) and polytetramethylene oxide (PTMO) are bonded along with silica on the molecular level, and which is doped with monododecyl phosphate (MDP) or 1,2-tungstophosphoric acid (PWA) as a proton conductivity donor.

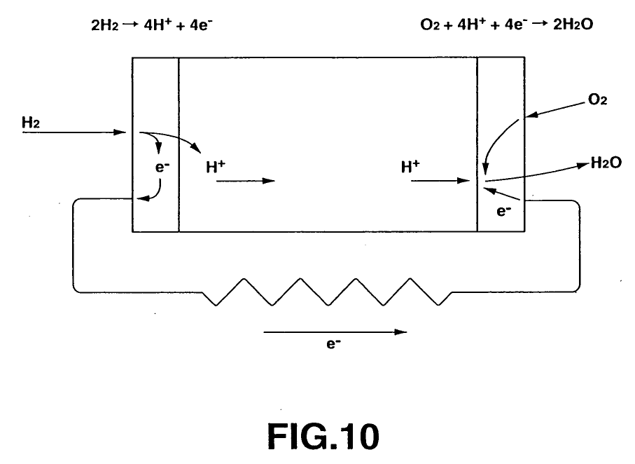

The proton conductor may also be a self-humidifying type electrolyte membrane. In this membrane, a trace amount of ultra fine particles of platinum catalyst and ultra-fine particles of oxides, such as TiO₂ or SiO₂, as terminal, are dispersed, as shown for example in FIG. 10. The cross-over hydrogen and oxygen are exploited in a reverse fashion to form water on a platinum catalyst and water then yielded is adsorbed and retained by the ultra-fine particles of the oxides to humidify the membrane from inside to keep the high water content ratio. The Pt—TiO₂ dispersed film, obtained on high dispersion of a trace amount (0.09 mg/cm²) of ultra-fine platinum particles with the particle size of 1 to 2 nm and ultra-fine particles of TiO₂ with the particle size of 5 nm (3 wt % of dry Nafion), is used as an electrolyte to enable cell operation in extremely high stability and with high performance (about 0.6 W/cm² for 0.4 to 0.6 V) even in the completely non-external humidifying state.

In any of the above modifications, humidification is unnecessary for protonic conduction, such that the meritorious effect in the present invention is maintained.

With use of the electrolyte film 11 containing a proton conductor, capable of conducting protons under a non-humidifying condition, as an electrolyte film, the hydrogen gas does not have to be provided, there being no necessity of providing a humidifier nor a space for mounting the humidifier, so that there is no necessity of using a separator of an intricate structure to render it possible to obtain the fuel cell compact in size.

The electrode module EM of a fuel cell employing an electrolyte film loaded with the proton conductor is explained more specifically.

The electrode module EM of the fuel cell of the present embodiment includes an electrolyte film 11 and a frame 20 supporting the electrolyte film 11. In the present embodiment, the fuel side is the upper side, while the oxygen side is the lower side, for explanation sake. Alternatively, the oxygen side and the fuel side may be reversed in their structures.

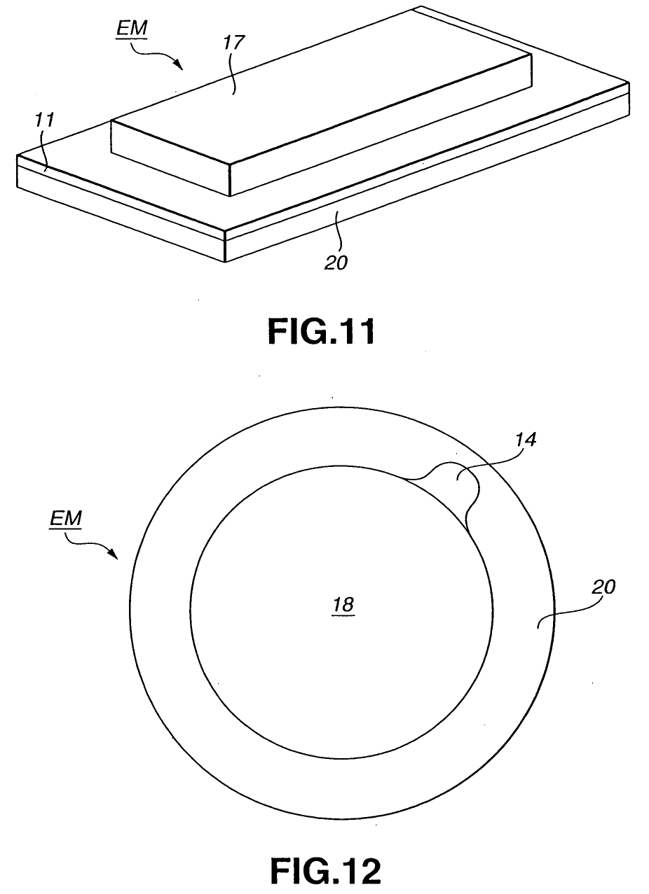

The frame 20 may be of a doughnut-shape as shown in FIG. 3 or of a rectangular shape as shown in FIG. 11. It may also be of any other shape, such as a polygonal shape or a free outer profile. As for the shape of the frame 20, the shape matched to the electrical equipment, not shown, applied to the electrode module EM of the fuel cell, may be rendered suitably selectable to match better to the shape of the preset electrical equipment, such as television receiver, video tape recorder, a portable video camera, a digital video camera, a digital camera, a portable or standstill type personal computer, facsimile, information terminals, including portable telephone sets, printers, navigation system, other OA equipment, lighting equipment or to domestic electrical utensils. Although the present embodiment employs a frame 20 with a thickness of 0.2 to 0.3 mm, this is not limitative and a thinner thickness of the frame 20 is more desirable.

The frame 20 may be formed by a metallic material, a composite material or a laminated material. The metal material may be of aluminum, as a non-ferrous metal, a ferrous metal or a variety of alloy materials.

The composite material may be of a glass material and an epoxy resin, a synthetic resin and various metal powders, reinforced plastics or engineering plastics.

The laminated structure may be plural layers of an electrically conductive material, an electrically non-conductive material or a semiconductor material.

With any of the above-mentioned materials, the frame 20 itself may be rendered electrically conductive, electrically non-conductive or electrical insulating.

On this frame 20 is affixed the electrolyte film 11, as shown in FIG. 2. In the present embodiment, the electrolyte film 11 is formed to the shape of the frame 20 and, as the electrolyte film 11 is tensioned to a preset value, it is affixed to one side of the frame 20 with an adhesive applied thereto. In affixing the frame 20 to the electrolyte film 11, it is also possible to bond the electrolyte film 11 to the frame 20, and to cut the electrolyte film 11 to the outer shape of the frame 20. The electrolyte film 11 may also be coated by a wet process on a release sheet and transferred after molding to the frame 20. Thin film handling may be facilitated by lining the electrolyte film 11 on the frame 20 as a structure.

When bonding the electrolyte film 11 to the frame 20, an insulating adhesive may be used as an adhesive 12 to assure insulation between the frame 20 and the electrolyte film 11. Simultaneously, sealing properties may be afforded by the adhesive.

On upper and lower surfaces of the electrolyte film 11, the metal layers 13, 14 and catalyst layers 15, 16 are applied, as shown in FIG. 2. It may be premeditated that the catalyst layers 15, 16 dissociate the hydrogen gas into protons and transmits the so dissociated protons, although the precise mechanism has not been determined. In the present embodiment, the metal layers 13, 14 and catalyst layers 15, 16 are formed mainly by sputtering.

However, the metal layers 13, 14 and catalyst layers 15, 16 may be formed not only by sputtering but also by exploiting various film forming means. For example, the metal layers 13, 14 for the electrodes may use a membrane forming process of applying plating or a pasting in order to improve electrical conductivity.

In the present embodiment the metal layers 13, 14 for the electrodes are formed to a thickness of, for example, approximately 100 nm, while the catalyst layers 15, 16 are formed to a thickness of approximately 20 nm. These metal layers 13, 14 and catalyst layers 15, 16 may also be laminated alternatively to provide a multi-layer film.

The metal layers 13, 14 for the electrodes may also be laminated in a lattice pattern to provide for locally increased thickness. That is, the metal layers 13, 14 are formed into patterns so as not to obstruct hydrogen transmission. It may be premeditated that, by partially increasing the thickness, not only may the electrical conductivity be improved, but also the hydrogen gas may be dissociated into protons to assure proton transmission more positively.

Although various electrically conductive metals may be used as the metal layers 13, 14 for the electrodes, gold (Au) is most preferred. As the catalyst layers 15, 16, platinum (Pt) is preferred.

On both sides (fuel side and the oxygen side) of the electrolyte film 11, now provided with the metal layers 13, 14 for the electrodes and the catalyst layers 15, 16, functional sheet layers having a porous structure (e.g., carbon fiber sheets; referred to below as sheet layers) 17, 18 are affixed. These sheet layers 17, 18 are provided with a function of holding and improving the strength of the metal layers 13, 14 for the electrodes and with a function of sending the respective gases (hydrogen and oxygen) dispersively and more satisfactorily to the catalyst to facilitate the electrochemical reaction as well as to remove the product (water).

A catalyst for oxygen may be carried by an adhesive side towards the electrolyte film 11 of the oxygen side sheet layer 18 to cause a more efficient reaction to take place between oxygen ions and transported protons. This surface is additionally coated with a hydrophobic coating of, for example, polytetafluoroethylene to pump out yielded water from the vicinity of the junction surface for dispersion into the sheet layer to permit the water to clear the sheet layer surface.

The electrode module EM is formed by pressing the two sheet layers 17, 18, metal layers 13, 14 for the electrodes and the catalyst layers 15, 16 into one unitary structure, as described above. This pressing is carried out at a pressure of approximately 50 to 100 kg/cm². It should be noted that the one of the sets is larger and the other set is smaller than the inner size of the frame 20 so that no force will be directly applied to the respective films.

That is, at least one of the layer of the fuel transmitting material (e.g., sheet layer 17) and the film of the oxygen transmitting material (e.g., sheet layer 18), which is the side lined with the electrolyte film 11, is larger than the inner frame dimension of the frame 20, with the opposite side layer being smaller than the in-frame dimension of the frame 20. That is, in the present embodiment, the metal layer 14, the catalyst layer 16 and the sheet layer 18 on the oxygen side are placed within a spacing X within the frame 20, while the metal layer 13, the catalyst layer 15 and the sheet layer 17 on the fuel side are the side lined with the electrolyte film 11, as shown in FIG. 2. Thus, in the present embodiment, the metal layer 13, catalyst layer 15 and the sheet layer 17, which are fuel side films, are larger in size then the metal layer 14, catalyst layer 16 and the sheet layer 18, which are fuel side films.

By layering various films on the electrode module EM and by having particles of a catalyst for hydrogen, such as Pt, carried by the adherent surface of the fuel side sheet layer 17 to the electrolyte film 11, the fuel gas (hydrogen) may be contacted over a wider area, so that more protons can be yielded and sent to the electrolyte film 11. Meanwhile, if a sufficient amount of the reaction gas is supplied, the sheet layers 17, 18 do not necessarily have to be provided and may safely be dispensed with.

If the frame 20 is electrically conductive, the electrolyte film 11 is bonded thereto with an insulator (an adhesive 12 in the present embodiment) so that poles of the cell are formed by the inner metal layer 14 (the metal layer towards the oxygen electrode in the present embodiment) and the outer metal layer 13 towards the fuel electrode side. It is noted that the metal layer 14 is formed on the electrolyte film 11 so that the frame 20 will be contacted with the metal layer 14. Meanwhile, the insulation is not limited to the above embodiment, such that insulation may be assured by forming a substrate holding the adhesive of the double-sided adhesive tape formed of an insulating material.

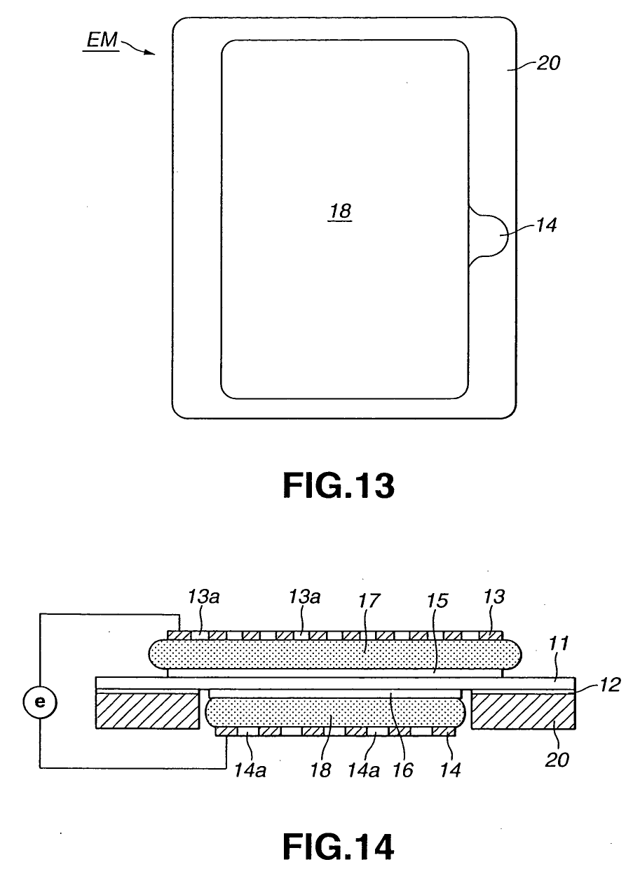

If, in distinction from the case in which the frame shown in FIG. 2 is of an insulating material, the frame 20 is of an insulating material, the metal layer 14 is extended and exposed to the frame 20 to use this extended portion of the metal layer 14 for establishing electrical contact with an external member. Meanwhile, the embodiments of FIGS. 12 and 13 are merely illustrative such that the shape of the elongated portion of the metal layer 14 may be selected optionally.

If the frame 20 is of an insulating material, the metal layers 13, 14, provided on the outer sides of the sheet layers 17, 18, may be provided with holes 13a, 14a, respectively, so that cell poles will be formed by the metal layer 14 on the oxygen electrode side and by the metal layer 13 on the fuel electrode side, as shown in FIG. 14.

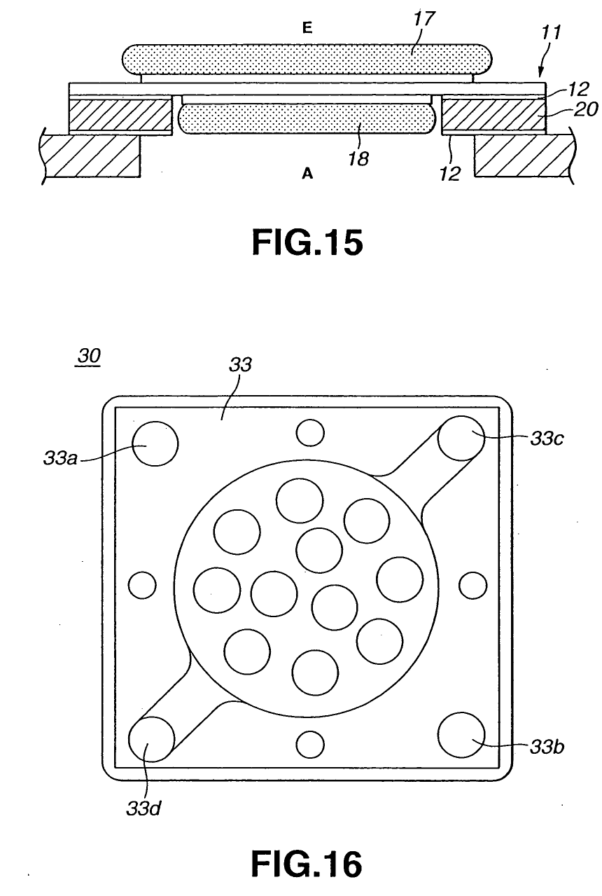

Moreover, for isolating the air side A and the fuel side E from each other, the frame 20 and the opposite side members may be bonded to each other using for example the adhesive 12, as shown in FIG. 15. In this case, the opposite side members are kept in communication with the air side.

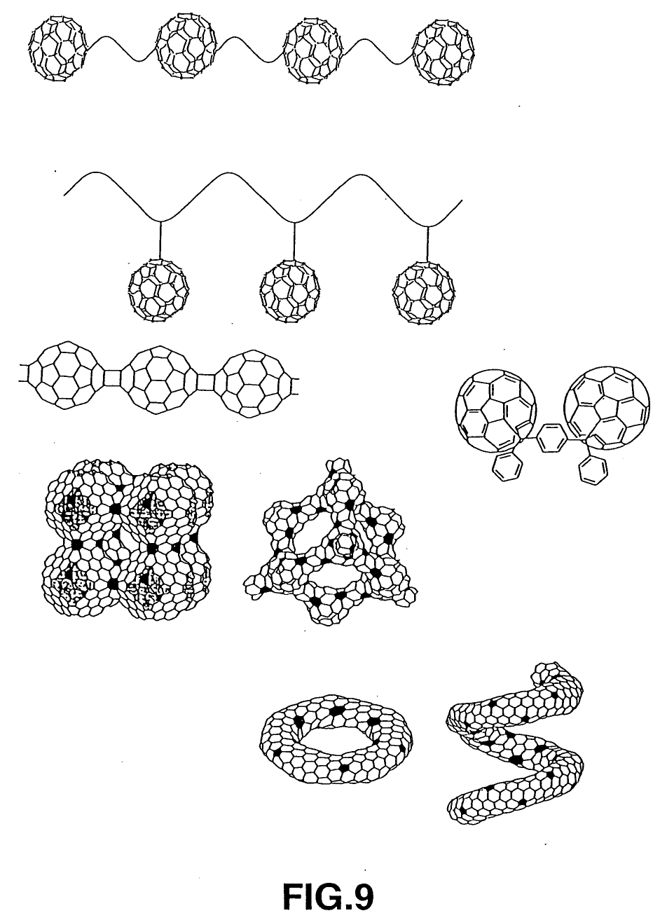

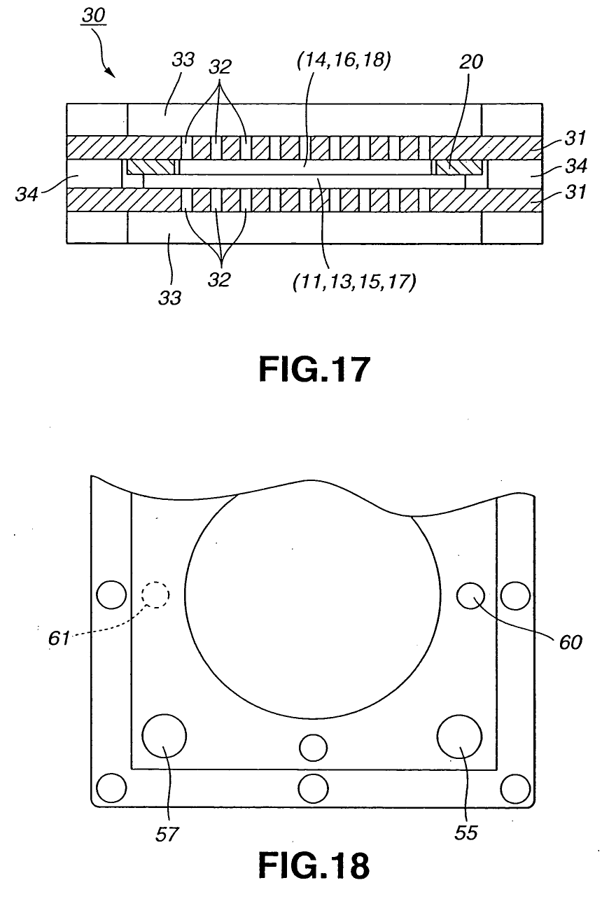

FIGS. 16 and 17 show a fuel cell 30. In the fuel cell 30 of the present embodiment, separators 31, each of which includes flow paths 32 for the fuel gas and air, are provided on both sides of the electrode module EM, and spacers 33, 33 are provided on both sides of the separators 31. In the present embodiment, the upper side in FIG. 9 is the air (oxygen) side.

As shown in FIG. 16, the spacer 33 is formed with an inlet 33a and an outlet 33b for hydrogen, as a fuel gas, and also with an inlet 33c and an outlet 33d for air (oxygen).

FIGS. 18 and 19 show an embodiment of a cell stack 50 employing the aforementioned fuel cells. Although the present embodiment of the cell stack is of a rectangular shape, the frame 20 of any desired suitable shape may be used, as described above. That is, the shape of the cell stack 50 may be suitably changed depending on the shape of the electrical equipment used.

The cell stack 50 of the present embodiment is a plural number of the fuel cells 30, stacked together. Specifically, a plural number of, herein three, fuel cells 30 are stacked together and held by a casing 51. This casing 51 includes a shell unit 52, lids 53 closing the opened ends of the shell unit 52, a pressuring plate 54, an inlet 55 for the fuel gas (hydrogen), an outlet 56 for the fuel gas (hydrogen), an inlet 57 for air (oxygen), an outlet 58 for air (oxygen), pressuring means 59, an inlet 60 and an outlet for cooling water.

Between the respective fuel cells 30 of the cell stack 50 of the present embodiment, there are provided cooling ducts 64, circulated by cooling water introduced via inlets 60 provided in the lids 53. In the present embodiment, the cooling ducts 64 are defined by cooling separators 63 and spacers 62. The temperature of the fuel cells 30 is adjusted by heat exchange with cooling water circulated through the cooling ducts 64. The cooling water used for the heat exchange is discharged via outlet 61 (see FIG. 18).

The opening ends of the shell unit 52 are formed with flanges 52a which are coupled by pressuring means 59, such as fasteners, inclusive of screws and nuts, welding or junction, for hermetically sealing the shell unit for defining the casing 51. For assuring sufficiently tight contact between the respective fuel cells in the casing 51, the pressuring plate 54 is used for applying a pressure when coupling the lids 53 to the shell unit. Since the pressure is applied at the frame 20 supporting the electrolyte films 11, no unneeded pressure is applied directly to the respective layers (films) of the fuel cells 30.

The fuel gas (hydrogen), supplied from a fuel gas storage unit (not shown), a hydrogen-containing metal, fuel gas tank or from a fuel gas generating device, is introduced via inlet 55 of the fuel stack 50 and led towards the gas inlet side of the respective fuel cells 30 so as to be used in the respective fuel cells 30. The fuel gas (hydrogen) passed through the fuel cells is discharged via outlet 56 of the cell stack 50. The fuel cell, thus discharged, is adjusted by a circulating channel, not shown, to a fuel gas of a preset concentration, so as to be re-introduced at the inlet 55 of the cell stack 50.

In similar manner, air (oxygen side) is introduced at the inlet 57 of air (oxygen) and led to the oxygen electrode side of each fuel cell 30 so as to traverse the respective fuel cells 30 and so as to be discharged via outlet 58 for air (oxygen) of the cell stack 50.

In the cell stack of the present embodiment, the electrolyte film 11 can be operated at a temperature range from a lower temperature to a higher temperature with the room temperature in-between. Thus, water yielded by reaction can be discharged as steam along with air, because the fuel cells 30 are at higher temperatures, such as approximately 100° C.

With the above-described structure, cooling may be made not only in the fuel cells but also from outer peripheral side of the fuel cells, so that, by layering a large number of the fuel cells, it is possible to provide a fuel cell system of a large capacity. Moreover, the water yielded may be vaporized by heat evolution in the fuel cell and discharged along with introduced air.

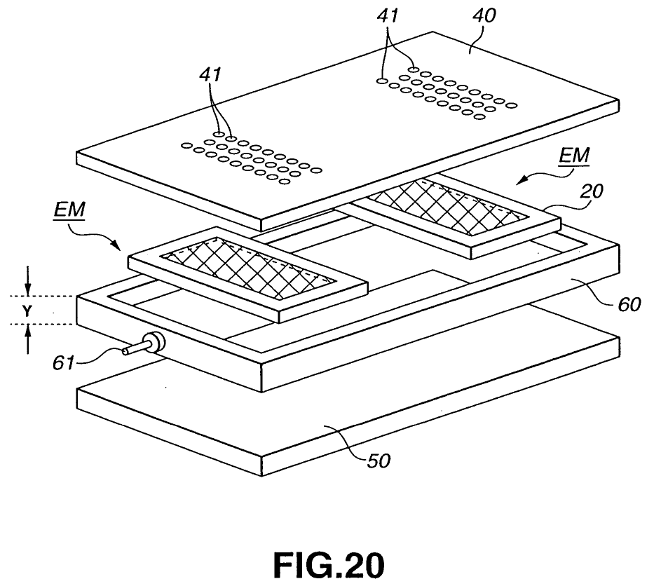

A cell system C prepared using the above-described electrode module EM and a variety of the films is hereinafter explained. This cell system C is sandwiched in a hermetically sealed state by an air side plate 40 and a hermetically sealing plate 50, as shown in FIG. 20. In the embodiment shown in FIG. 20, two electrode modules EM and various films are used. The air side plate 40 is formed with openings or through-holes for supplying air to the air side electrode. On a lateral surface of the air side plate 40 is formed a circuit pattern for electrical contact, not shown.

A plural number of plural electrode modules EM and various films are mounted air-tightly on this air side plate 40, and air is supplied only through the openings or holes 41 provided in the air side plate 40. On the other hand, the hermetically sealed plate 50 hermetically seals the surfaces contacted with the fuel sides of the various films and the electrode modules EM.

In the present embodiment, a seal frame 60 is used in addition to the air side plate 40 and the hermetically sealed plate 50. The air side plate 40 and the hermetically sealed plate 50 hermetically seal the front and back sides (upper and lower sides in the FIG. 20) for sandwiching the electrode modules EM and various films in-between. The width Y of the seal frame of the present embodiment is approximately equal to the combined width of the air side plate 40, electrode module EM, various films and the hermetically sealed plate 50.

There is provided an opening for establishing communication between the hermetically sealed plate 50 and the surfaces of the various films contacting with the fuel sides and the electrode modules EM. This opening, not shown, is provided with an offset towards the fuel side. The seal frame 60 is provided with an injection port 61 communicating with the opening, and the fuel gas is injected from this injection port 61. When the fuel gas, such as hydrogen, is injected, the fuel side electrodes of the various electrode modules EM are exposed to the atmosphere of the fuel gas and the proton exchange reaction takes place on the electrolyte film.

The air side plate 40, the hermetically sealed plate 50 and the seal frame 60, used in the embodiment shown in FIG. 20, may be formed partially or entirely from flexible sheets. These flexible sheets may be suitably selected, depending on the using environment and operating conditions of the fuel cell, from the sheets or films of polyvinyl chloride (PVC) resin, polypropylene resin (PP), polyphenylene sulfide (PPS) and thermally resistant resins, such as polyimide resins. Of course, flexible sheets may similarly be used in the following instances.

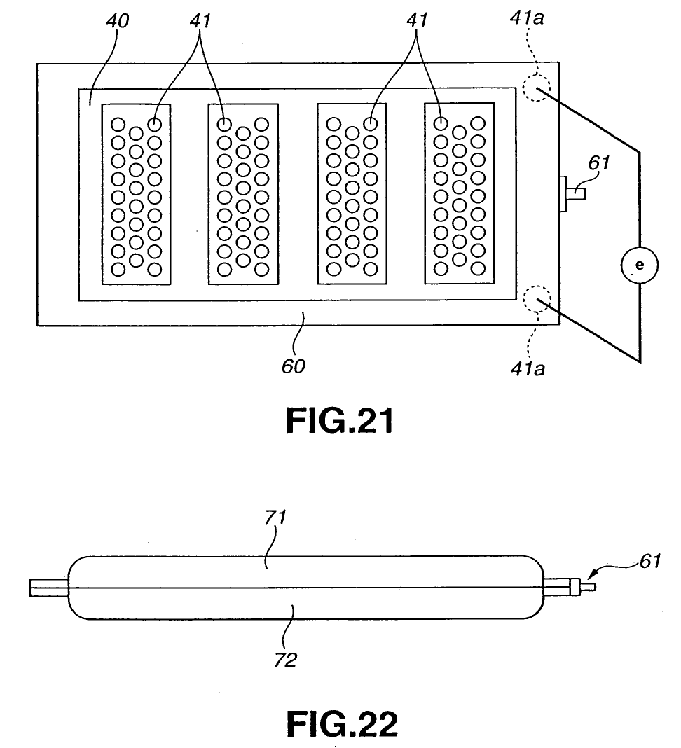

FIG. 21 is a schematic view showing the back side of the air side plate, according toe a modification of the embodiment shown in FIG. 20, as seen from the seal frame side. In the embodiment of FIG. 21, four electrode modules EM with various films thereon are used. The openings or through-holes 41 of the air side plate 40 are formed in meeting with the mounting positions of the electrode module EM. The embodiment of FIG. 21 shows the electrical connection across plural electrode modules EM. A connection pattern for electrical connection is formed on the back surface of the air side plate 40 lined with the electrode module EM, and electrical conduction is established on ends 41a of this connection pattern.

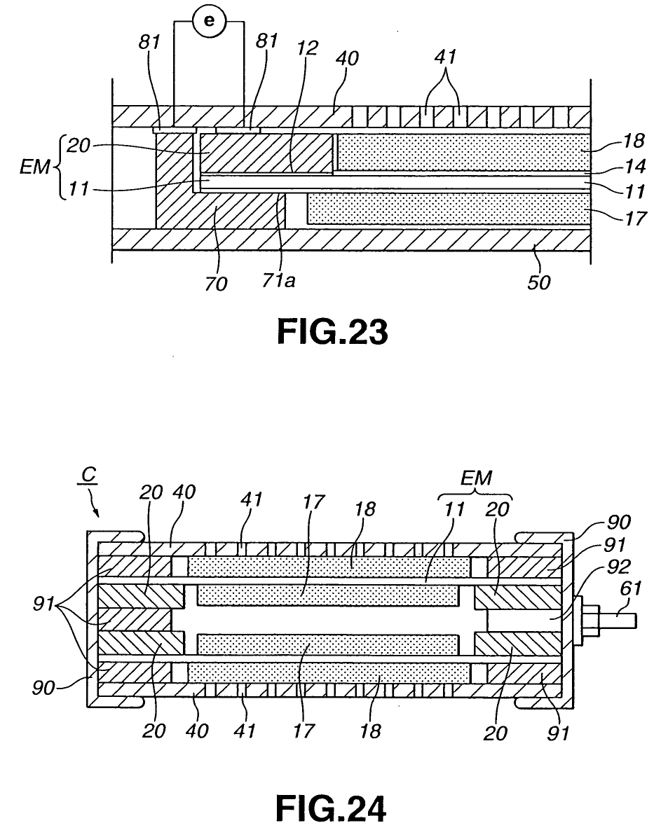

FIG. 22 shows a side view of a modification of the fuel cell. In the embodiment of FIG. 22, the electrode module EM and the various films are hermetically sealed by two flexible sheets 71, 72. The inner structure of the cell system C in the present embodiment may be configured as shown in FIGS. 20 and 21, as described previously, or as shown in FIGS. 23 to 26.

FIG. 23 illustrates the electrical connection across the electrode modules EM. In the present embodiment, the electrode modules and the various films thereon are held by the air side plate 40 and the hermetically sealed plate 50. In addition, a supporting member 70 comprised of a surface contacting with oxygen and a surface contacting with the fuel side provided on the opposite side surface is interposed between the air side plate 40 and the hermetically sealed plate 50.

Although the supporting member 70 of the present embodiment is substantially L-shaped in cross-section, this is for supporting the electrode module EM and the various films thereon by its surface 71a, such that there is no limitation to the shape of the supporting member 70 provided that the supporting member 70 has this supporting function. The supporting member 70 also has the contacting function and is formed with a connection pattern 81 on the junction surface with respect to the electrode module EM. In the present embodiment, the air side plate 40 and the electrode module EM are shown separated from each other to clarify the structure. A portion of the electrolyte film 11 of the electrode module EM is contacted with a connection pattern 81 via electrically conductive adhesive 12 and the frame 20 of an electrically conductive material, while being contacted with another connection pattern 81 through the supporting member 70. Although the supporting member 70 is configured for having a contact function, it is also possible to establish the connection by other means.

FIG. 24 shows an illustrative cross-sectional view showing an exemplary structure of the cell system and specifically shows an instance of an electrode module EM in which the fuel side film of the frame 20 is selected to be smaller than the frame size. That is, two air side (oxygen side) plates 40, each carrying the electrode module EM, or two flexible sheets, are mounted back-to-back, that is with the fuel sides facing each other, with the respective ends being sealed with sealing members 90 to provide a hermetically sealed structure. Meanwhile, 90 and 91 in FIG. 24 are a spacer and spacer/fuel gas nozzle communication tube, respectively.

That is, the air side and the fuel side are directed outwards and inwards, respectively, and the fuel gas is injected from the inside. By so doing, the fuel can be supplied to both side electrode modules EM and various films thereon to provide the compact shape of the cell C. Thus, the surfaces of the electrode modules EM and the various films, contacting with the fuel side, are made to face each other with the frames 20 and the spacers 91 in-between, and the fuel gas is supplied to these facing surfaces.

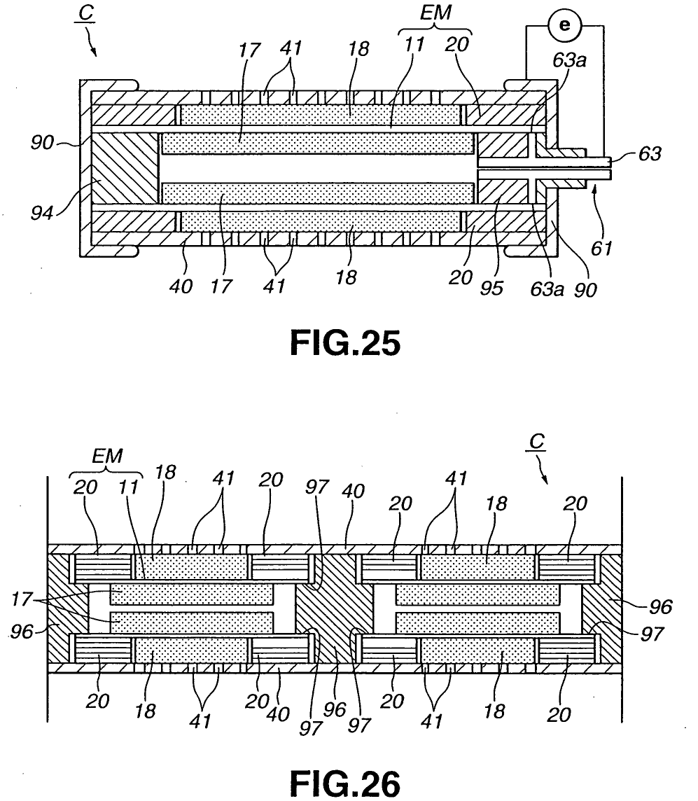

FIG. 25 is an illustrative cross-sectional view showing an exemplary cell structure. In the present embodiment, in distinction from the structure of FIG. 24, the electrode module EM and the various films, having the same structure as that shown in FIG. 2, are used. In the present embodiment, the space for the fuel gas is defined between the electrode module EM and the various films, using a spacer 94 and a spacer/fuel gas nozzle communication tube 95. Moreover, in the present embodiment, a tube 63 that can be passed in the inside of the injection port 61 is used. A portion 63a of the tube 63 is contacted with the metal layer 13 used as an electrode. This metal layer 13 is rendered electrically conductive by contacting with the electrically conductive sealing member 90 in case the frame is of an insulating material. If the frame 20 is an electrically conductive member, the metal layer 13 is rendered electrically conductive by contact between the frame 20 and the electrically conductive sealing member 90.

In the present embodiment, the metal layer 13 is provided between the electrolyte film 11 and the sheet layer 18, as in FIG. 2. The connecting portion may, however, be formed by through-holes provided in a portion of the electrolyte film 11 for connection on the nozzle tube side.

In the present embodiment, connection is made between the tube 63 and the electrically conductive sealing member 90.

FIG. 26 is a schematic cross-sectional view showing an illustrative structure of a cell system. Specifically, the present embodiment shows a structure of two cells coupled together in a horizontal direction. That is, in the present embodiment, two cell structures, each of which is shown in FIG. 25, are coupled together in a horizontal direction.

The electrode module EM and the various films of the present embodiment are of the same structure as that shown in FIG. 25. A spacer 96 is interposed between neighboring electrode modules EM and the various films formed thereon and the fuel gas is supplied to the fuel-side facing surfaces of the electrode modules EM and the various films formed thereon to constitute the fuel cell. In the present embodiment, the spacer 96 supports the electrode modules EM by surfaces 97, and is interposed between the respective electrode modules EM placed between the air side (oxygen side) plates and the various films formed thereon. Meanwhile, the electrical contact, supply of fuel gases and nozzles may be as described in connection with the above-described embodying the present inventions.

It is also possible to pressurize the fuel gas to provide operating conditions in which a pressure differential is produced between the fuel gas side and the air side. In such conditions, the gas pressure is sustained by the frame 20 of the electrode module Em and by the fuel side sheet layer 17. Moreover, the respective electrode modules EM are arranged so that the gap between the air side plate 40 and the electrode is minimized to limit the flexure to provide for scattering of the force towards the electrolyte film 11.

The pressurized fuel gas is supplied to the hermetically sealed space on the fuel side to adjust the pressure to a constant value to limit the supply quantity such as to compensate pressure reduction due to gas consumption.

The air side plate 40, electrode module EM and the hermetically sealed plate 50 are of desired shape, such that at least the air side plate 40, electrode module EM and the hermetically sealed plate 50 may be of substantially the same outer profile.

By this construction, the fuel cell of an optimum shape may be provided to match to the shape of, for example, a preset electrical equipment, a video tape recorder, a portable camera, a digital video camera, a digital camera, a portable or standstill personal computer, a facsimile, an information terminal, including a portable telephone set, a printer, a navigation system, other OA equipment, a lighting equipment or a domestic electrical utensil.

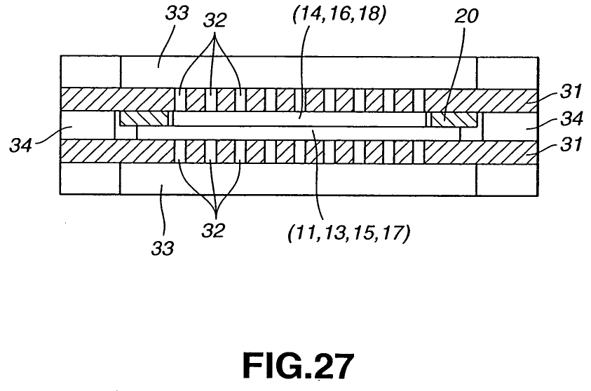

FIG. 27 is a schematic cross-sectional view of a fuel cell having a separator. The fuel cell of the present embodiment includes a pair of separators 31, having ducts 32 for a fuel gas and air on both sides of the aforementioned electrode module EM, and a pair of spacers 33 on both outer sides of the separators. In FIG. 27, 34 denotes a frame. The electrode module EM and the various films thereon are surrounded by the separators 31 and the frames 34.

Industrial Applicability

According to the present invention, employing an electrolyte film containing a proton conductor capable of conducting protons under non-humidifying conditions, proton transfer by domino effects is enabled such that water humidification, gas humidification, control of moisture in the film, exact gas flow control or humidifying water control are unnecessary in a manner different from the case of the electrolyte film of the perfluorosulfonic acid to simplify the system to lower the cell cost.

In addition, the electrolyte film containing the proton conductor under non-humidifying conditions has such characteristics as ease in surface processing and broad temperature range and hence the electrode module is of a simplified structure and lends itself to mass production and hence reduction in cost.

Moreover, since the present invention holds an electrolyte film, the electrolyte film is ready to handle as an assembly to realize a scalable cell from a small capacity to a large capacity cell.

In addition, with the electrolyte film of the present invention, in which the electrolyte film containing the proton conductor capable of proton conduction under non-humidifying condition is supported by a frame, the proton conductor is consisted mainly of a carbonaceous material, into which are introduced proton dissociating groups, and in which the carbonaceous material is comprised of fullerene molecules and optionally a binder, there is no necessity of exact control of the moisture in the fuel gas, and the proton conductor may be of a sufficient strength by being bound with a binder, if one is used, while the separator may be simpler in structure.

1. An electrode module comprising:
an electrolyte film containing a proton conductor capable of conducting protons under a non-humidifying condition; and
a frame for supporting the electrolyte film.

2. The electrode module according to claim 1 wherein the proton conductor is consisted mainly of a carbonaceous material to which proton dissociative group is introduced.

3. The electrode module according to claim 2 wherein said carbonaceous material is fullerene molecules.

4. The electrode module according to claim 1 wherein said electrolyte film contains a binder.

5. The electrode module according to claim 1 wherein said frame is provided with a contact portion with said electrolyte film.

6. The electrode module according to claim 1 wherein said frame is formed of an electrically conductive material.

7. The electrode module according to claim 6 wherein said frame is electrically connected to another electrically connectable member.

8. The electrode module according to claim 1 wherein said frame is formed of an electrically insulating material.

9. The electrode module according to claim 8 wherein a portion by which said frame is to be electrically contacted with an external member is provided as a portion of a metal layer for an electrode.

10. The electrode module according to claim 1 wherein said frame is formed of a composite material.

11. The electrode module according to claim 10 wherein said composite material contains at least a glass material and an epoxy resin.

12. The electrode module according to claim 1 wherein an electrode film and a catalytic layer are formed on said electrolyte film a film forming process at least containing sputtering, plating and pasting.

13. The electrode module according to claim 12 wherein one or more of said electrode films and one or more of said catalyst layers are alternately stacked to provide a multi-layer film comprised of two or more layers,

14. An electrode module comprising:
a frame for supporting an electrolyte film;
a film of a porous fuel transmitting material carrying a catalyst layer; and
a film of a porous oxygen transmitting material carrying a catalyst layer and particles of a hydrophobic material;
at least one of the film of the fuel transmitting material and the film of the oxygen transmitting material lined on said frame being larger in size than the inner size of said frame, with the opposite side film being smaller in size than the inner size of said frame.

15. An electrode module comprising:
a frame for supporting an electrolyte film;
a metal layer for an electrode and a catalyst layer, provided on each of the surfaces of said electrolyte film;
a film of a porous fuel transmitting material carrying a catalyst and particles of a hydrophobic material; and
and a film of a porous oxygen transmitting material, carrying a catalyst layer and particles of a hydrophobic material,
at least one of the film of the fuel transmitting material and the film of the oxygen transmitting material being larger in size on the film lining side, with respect to the inner size of said frame, with the opposite side film being smaller in size.

16. A fuel cell comprising an electrode module including a frame for supporting
an electrolyte film, a film of a porous fuel transmitting material carrying a catalyst layer and a film of a porous oxygen transmitting material carrying a catalyst layer and particles of a hydrophobic material, and
a duct for cooling water provided on at least one side of said electrode module.

17. A fuel cell comprising an electrode module including a frame for supporting
an electrolyte film, a metal layer for an electrode provided on each side of said electrolyte film with a catalyst layer, a film of a porous fuel transmitting material carrying a catalyst, and a film of a porous oxygen transmitting material carrying a catalyst layer and particles of a hydrophobic material, and
a duct for cooling water provided on at least one side of said electrode module.

18. The fuel cell according to claim 16 or 17 wherein at least one of the film of the fuel transmitting material and the film of the oxygen transmitting material lined on said frame is larger in size than the inner size of said frame, with the opposite side film being smaller in size than the inner size of said frame.

19. A cell stack comprising a plural number of the fuel cells according to claim 16 or 17 stacked together and arranged in a casing, said fuel cells being secured in position by being pressured by a pressuring plate at a portion of a frame supporting said electrolyte film.

20. A cell stack comprising a plural number of the fuel cells according to claim 16 or 17 stacked together and arranged in a casing, such as to form a duct for cooling water between the respective fuel cells, said fuel cells being secured in position by being pressured by a pressuring plate at a portion of a frame supporting said electrolyte film.

21. A fuel cell comprising a cell system, said cell system including:
an air side plate capable of being supplied with air;
at least one electrode module mounted air-tightly to said air side plate and having a surface contacting with oxygen;
a hermetically sealed plate for hermetically sealing the surface of said electrode module corresponding to a fuel side of said electrode module opposite to said side contacting with oxygen; and
an injection port for introducing a fuel gas between said hermetically sealed plate and the surface of said electrode module contacting with said fuel side.

22. A fuel cell comprising a cell system, said cell system including at least one electrode module having an air side plate capable of being supplied with air and a surface mounted air-tightly to said air side plate for contacting with oxygen; and
a constituent member having a surface contacting with a fuel, lying oppositely to said oxygen contacting surface;
the fuel contacting surfaces of said constituent members facing the fuel side with a spacer in-between; a fuel gas being supplied to the facing surfaces.

23. A fuel cell comprising a cell system, said cell system including at least one electrode module having an air side plate capable of being supplied with air and a surface mounted air-tightly to said air side plate and provided with a surface contacting with oxygen; and
a plurality of constituent members each having a surface contacting with a fuel side, said surface lying oppositely to said oxygen contacting surface;
the fuel contacting surfaces of said constituent members facing one another with a plurality of spacers in-between, said spacers being provided at a preset interval from one another, to form a plurality of columns; a fuel gas being supplied to the facing surfaces.

24. The fuel cell according to any one of claims 21 to 23 wherein said air side plate, said electrode module and the hermetically sealed plate are of desired shapes and wherein at least the air side plate, electrode module and the hermetically sealed plate are of substantially the same outer shape.

25. The fuel cell according to any one of claims 21 to 23 wherein the electrical connection across a plurality of said electrode modules in case there are such plural electrode modules is made by a connection pattern provided on a surface of the air side plate lined with the electrode module, a portion of an electrode film being contacted with said connection pattern and also contacted with a connection pattern of another electrode module through a support having a contact function of contacting with an opposite side of said frame to assure electrical connection.

26. The fuel cell according to any one of claims 21 to 23 wherein separators having ducts for a fuel gas and air are arranged on both lateral sides of said electrode module.

27. The fuel cell according to any one of claims 21 to 23 wherein at least one of said plates is a flexible sheet.

28. The fuel cell according to any one of claims 21 to 23 wherein said electrode module supports an electrolyte film by a frame, said electrolyte film containing a proton conductor capable of conducting protons under a non-humidifying condition.

29. The electrode module according to claim 28 wherein the proton conductor is consisted mainly of a carbonaceous material to which a proton dissociative group is introduced.

30. The electrode module according to claim 29 wherein said carbonaceous material is fullerene molecules.

31. The electrode module according to claim 28 wherein said electrolyte film contains a binder.

32. The electrode module according to claim 28 wherein said frame is provided with a contact portion with said electrolyte film.

33. A fuel cell comprising a cell system, said cell system including at least one electrode module having an air side plate capable of being supplied with air and a surface mounted air-tightly to said air side plate and provided with a surface contacting with oxygen; and
a plurality of constituent members each having a surface contacting with a fuel, lying oppositely to said oxygen contacting surface;
the fuel contacting surfaces of said constituent members facing one another with a plurality of spacers in-between, said spacers being provided at a preset interval from one another, to form a plurality of columns; a fuel gas being supplied under pressure to the facing surfaces to produce a pressure difference with respect to the air side.

34. The fuel cell according to claim 33 wherein said air side plate, said electrode module and the hermetically sealed plate are of desired shapes and wherein at least the air side plate, electrode module and the hermetically sealed plate are of substantially the same outer shape.

35. The fuel cell according to claim 33 wherein the pressurized fuel gas s supplied at a pressure adjusted to a constant value and in a controlled supply quantity to compensate pressure decrease caused by consumption of the fuel gas.
